(19) United States
(12) Patent Application Publication
(10) Pub. No.: US 2024/0320467 A1
(43) Pub. Date: Sep. 26, 2024

(54) INTEGRATED KNOWLEDGE GRAPH SYSTEM

(71) Applicant: Morgan Stanley Services Group Inc., New York, NY (US)

(72) Inventor: Eren Kurshan, New York, NY (US)

(21) Appl. No.: 18/189,527

(22) Filed: Mar. 24, 2023

(51) Int. Cl. G06N 3/042; G06N 3/063

(52) U.S. Cl. CPC G06N 3/042; G06N 3/063

(57) ABSTRACT

An integrated knowledge graph system includes neural arrays, a query processing engine, and a policy/compliance engine. Each neural array contains circuits that represent neurons and synapses. Each neuron and synapse has a processing, communication, learning and storage capability. Entities and relationships of the knowledge graph are within the plurality of neural arrays. The query processing engine is coupled in parallel to the neural arrays and processes incoming queries and passes process queries to targeted entities and relationships representing the plurality of neural arrays. The policy/compliance engine is coupled to the plurality of neural arrays and sets policies for processing in the neurons and synapses of the plurality of neural arrays. A method implements the integrated knowledge graph system.

### FIELD OF THE DISCLOSURE

The present disclosure relates to knowledge graphs, and more particularly relates to systems and methods for integrated, computational knowledge graphs.

### BACKGROUND OF THE DISCLOSURES

A knowledge graph is a representation of a knowledge base using a graph-based structured data model or topology. It is commonly used to represent real-world entities such as places, events, objects and concepts as well as the relationships between them. In knowledge graphs, nodes typically represent real-world entities such as persons, places, products, and other objects. The edges represent relationships between these entities. As greater complexity is added, a knowledge graph can implement a semantic network with heterogeneous directed graph characteristics and with multiple entity and edge types. To accommodate such complexity, knowledges graphs can also incorporate a schema layer that defines classes and relationships of entities.

Knowledge graphs are useful because the data represented in the knowledge graph can be explored via structured queries. In addition, knowledge graphs can be used to interpret data and infer new facts. Knowledge graphs can also combine different types of data sources and relationships in siloed databases, providing the ability to represent complex relationships among different kinds of entities in real-world applications and incorporate hierarchies and semantics.

An example conventional knowledge graph is shown in FIG. 1. In this simplified example, the knowledge graph 100 represents facts related to the astronomer Johannes Kepler. Kepler himself is a first node 105 in the knowledge graph. A number of additional nodes represent entities that are related, directly or indirectly, to Kepler. Node 110 is the Kepler Space Telescope which is named after Kepler. An edge 108 drawn between node 110 (Telescope) and node 105 (Kepler) is marker “named after”, which characterizes the relationship between node 110 with respect to node 105. Similarly, there are nodes for laws of planetary motion 115, German 120 and astronomer 125 which are connected to Kepler 105 by respective relationship edges “published by” 112, ethnicity 118, and occupation 122 (the latter two point from the Kepler node to nodes 120 and 125). There is a further node 130, which represents NASA. NASA node 130 which is not connected directly to the Kepler node 105 by rather only connected to the Space Telescope 110 by relationship “operator” 132. In this manner, NASA is connected to Kepler indirectly via two relationship connections or by “two degrees.” Although this is a simplified example, with only a single second degree relationship, it is of course understood that a complex knowledge graph can have more indirect connection of 3^{rd}, 4^{th} degrees, etc.

Despite having numerous advantages, knowledge graphs face performance challenges, especially in large scale applications. Algorithm speeds in processing knowledge graphs with large numbers of nodes, edges and additional complexity are typically lower than desired. While some hardware and software approaches to these challenges have been proposed, and are helpful for some application, many of the challenges remain.

There is accordingly a need for a knowledge graph system that improves knowledge graph processing performance more generally.

### SUMMARY OF THE DISCLOSURE

In some embodiments, the one or more processors are further configured with a machine learning algorithm which receives as inputs knowledge graphs, historical and streamed data, and which is trained learn the status of relationships between entities.

In one embodiment, an integrated knowledge graph system comprises a plurality of neural arrays, a query processing engine, and a policy/compliance engine. Each of the plurality of neural arrays contains circuits that represent neurons and synapses. Each of the neurons and synapses has a processing, communication, learning and storage capability. Entities and relationships of the knowledge graph are configured within the plurality of neural arrays. The query processing engine is coupled in parallel to the plurality of neural arrays and is configured to process incoming queries and to pass process queries to targeted entities and relationships representing the plurality of neural arrays. The policy/compliance engine is coupled to the plurality of neural arrays and is configured to set policies for processing in the neurons and synapses of the plurality of neural arrays.

The query processing engine can be configured to locate an entity represented in the knowledge graph within the plurality of neural arrays, and to pool neighbors of the entity in the knowledge graph as represented in the plurality of neural arrays. The pooled neighbors in the plurality of neural arrays can be configured to perform accelerated risk calculations. The policy/compliance engine can be configured to permit or restrict access to data represented in one or more parts of the knowledge graph represented in the plurality of neural arrays based on the set policies. The integrated knowledge graph system can further comprise one or more non-volatile memory storage units coupled to the plurality of neural arrays. The integrated knowledge graph system can further comprise a central processing unit (CPU) and one or more vector processing units. The CPU can be coupled to the plurality of neural arrays, the query processing engine and the policy/compliance engine. The one or more vector processing units can be coupled to the CPU, the plurality of neural arrays, the query processing engine, and the policy/compliance engine.

The plurality of neural arrays, the query processing engine, and the policy/compliance engine can be implemented on a dedicated hardware device. Alternatively, the plurality of neural arrays, the query processing engine, and the policy/compliance engine can be implemented on neuromorphic chip device. In another alternative embodiment, the plurality of neural arrays, the query processing engine, and the policy/compliance engine can be implemented using a customizable hardware device. The integrated knowledge graph system can further comprise a three-dimensional architecture including one or more memory layers. A CPU can constitute one layer of the three-dimensional architecture. The CPU can be interconnected to the one or more memory layers. The one or more memory layers can be further interconnected to the plurality of neural arrays, which constitutes another distinct layer. The one or more memory layers can comprise a first dynamic memory layer coupled to the CPU and a second non-volatile storage array layer interconnected to the dynamic memory layer and to the plurality of neural arrays.

In another embodiment, a method for mapping data onto a knowledge graph comprises receiving data targeted for mapping onto the knowledge graph; identifying elements within the data including entity-level characteristics, size, entity-type, and functional requirements; determining one or more neural arrays having capabilities suited for mapping of the identified elements, wherein the neural arrays contain circuits that represent neurons and synapses, each of the neurons and synapses having processing, communication, learning and storage capability; and mapping the elements onto the suited neural arrays.

The neural array can include or can be connected to functional block components configured to process the identified elements within the data. The functional block components can comprise at least one of a specialized accelerator and an application-specific functional unit. The one or more neural arrays can be implemented on a dedicated hardware device. Alternatively, the one or more neural arrays can be implemented on a neuromorphic chip device.

In a further embodiment, a method queries a financial services knowledge graph comprising entity and relationship components that are configured and represented in a plurality of neural arrays comprising circuits that represent neurons and synapses, with each of the neurons and synapses having processing, communication, learning and storage capability. The method comprises receiving a query for obtaining or updating information in a knowledge graph; determining whether the query meets requirements for compliance by consulting a policy/compliance engine that is coupled to the plurality of neural arrays; and after the determining step, when requirements for compliance are not met, restricting access to one or more components of the knowledge graph, and adjusting the query to accommodate for the restricted access. The method further comprises submitting the adjusted query, via an input/output system, to the knowledge graph to obtain or update the information in the knowledge graph.

After the determining step, when requirements for compliance are met, the method can comprise submitting the query, via an input/output system, to the knowledge graph to obtain or update the information in the knowledge graph. The method can further comprise sending results of the query including obtained or updated information to the policy compliance engine, and determining whether the results of the query meet with compliance requirements. The input/output system can submit multiple queries to the knowledge graph in parallel and the knowledge graph processes the queries in parallel.

### BRIEF DESCRIPTION OF THE DRAWINGS

FIG. 1 is a conventional knowledge graph according to the prior art.

FIG. 2 is a schematic block diagram showing functional capabilities of an example entity according to an embodiment of the present disclosure.

FIG. 3 is a schematic diagram illustrating a computational knowledge graph with entities having a range of different capabilities according to the present disclosure.

FIGS. 4A and 4B are schematic diagrams depicting two examples of using learning functions with entities in the computational knowledge graph.

FIGS. 5A, 5B and 5C illustrate stages of an exemplary method for processing a query in a computational knowledge graph according to the present disclosure.

FIGS. 6A-6D illustrate stages of another query processing example according to the present disclosure.

FIG. 7 depicts parallel processing of several queries and update processes by a computational knowledge graph according to the present disclosure.

FIG. 8 is a schematic block diagram of a system for carrying out queries and other operations using a computational knowledge graph according to the present disclosure.

FIG. 9 is a schematic block diagram showing general functional libraries that are used for configuring entities as well as libraries for customizing entity-level characteristics suited for particular applications.

FIG. 10A is a flow chart of an exemplary method for processing a query using a computational knowledge graph according to an embodiment of the present disclosure.

FIG. 10B is a flow chart of an example method for processing a query component at the entity (local) level according to an embodiment of the present disclosure.

FIG. 11 is a block diagram of a system embodiment for a computational knowledge graph according to the present disclosure.

FIG. 12A illustrates a knowledge graph coupled to a Von Neumann computing architecture as known in the prior art.

FIG. 12B illustrates an integrated knowledge graph according to the present disclosure.

FIG. 13 is a schematic block diagram of an embodiment of an integrated knowledge graph system for implementing a computational knowledge graph according to the present disclosure that uses a neuromorphic architecture.

FIG. 14 is a schematic block diagram of an alternative embodiment of an integrated knowledge graph system for implementing a computational knowledge graph according to the present disclosure that employs aspects of conventional Von Neumann architecture.

FIG. 15 shows a similar system as shown in FIG. 13 customized for a financial services application.

FIG. 16 is a schematic view of an embodiment of an integrated knowledge graph system using a three-dimensional integrated architecture.

FIG. 17 is a schematic illustration of knowledge graph processing using the neuromorphic systems.

FIG. 18 is a flow chart of an embodiment of a method of mapping a computational knowledge graph according to the present disclosure.

FIG. 19 is a flow chart of an embodiment of a method for query processing in a computation knowledge graph using policies according to the present disclosure.

FIG. 20 a flow chart of another embodiment of a method for query processing using policies in a financial knowledge graph according to the present disclosure.

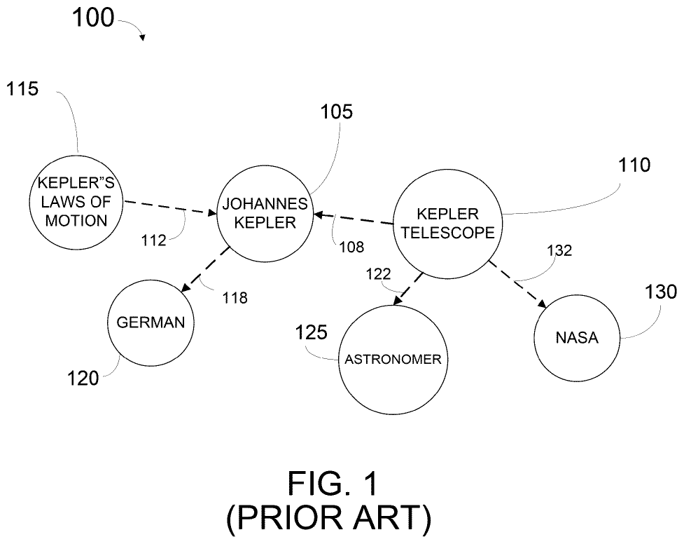

### DESCRIPTION OF CERTAIN EMBODIMENTS OF THE DISCLOSURE

In the system and methods of the present disclosure, the challenges are addressed by: i) incorporating computing and communication capabilities in the knowledge graph itself; ii) integrating storage, computing and communication capabilities of the knowledge graph; and iii) removing database-only restriction in knowledge graph definitions. When these measures are implemented, the resulting knowledge graph becomes an integrated financial graph system (an integrated financial graph system when used in financial applications) and an integrated knowledge processing system having capabilities exceeding the purely “database” capabilities of conventional knowledge graphs.

Due to the added capabilities, the knowledge graph of the present disclosure can also be referred to as a “computational knowledge graph”, with computing, storage and communication capabilities. The computing, storage and communication capabilities enable the knowledge graph to be defined beyond the conventional representation of entities and relationships to include functions and communication capabilities.

The computation knowledge graph of the present disclosure can be implanted using a system in which each entity has its own functional and/or processing capabilities. In software-based implementations, the entity capabilities are configured as functional capabilities of the knowledge graph. In hardware-based implementations, such as neuromorphic hardware mappings or dedicated hardware embodiment, the processing capability is embodied using “neural elements”, which are a hardware approximation of neuron elements and behavior. In some cases, entities are associate with a type (e.g., person, location, publication, device, rule, etc.) and each entity type is customized with specific functions and processing capabilities, as well as storage capacity.

Each relationship can be defined functionally; that is to say that the connectivity between entities can be configured and functionally defined. New kinds of relationship and communication types are defined for knowledge graph operations. For example, two entities that are not related to each other can still be connected to each other via a query function so that they can pass information for the processing of a query. In the knowledge graph, each entity is configured to perform the knowledge graph functions on its own or in concert with connections. As an example, during a query regarding an entity, the entity can broadcast a message to neighbors in the knowledge graph and receiving answers to the query therefrom. In some embodiments, each entity has learning capabilities. In certain embodiments, the learning capabilities are configured through underlying neural elements/neural networks or neural network components. Complex entities may be represented and mapped onto multiple layers depending on the type of characteristics. Furthermore, entity-specific functions can be defined through a knowledge graph or schema for complex entities.

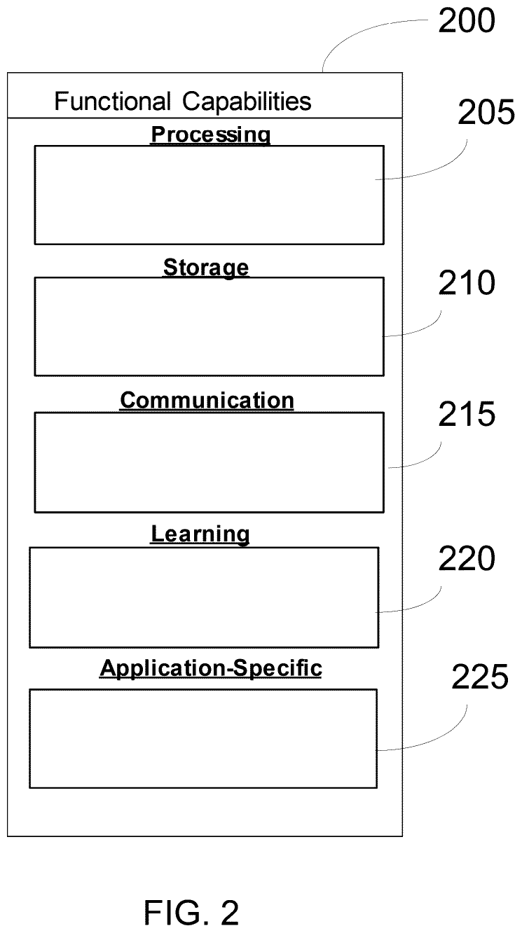

Each entity Ei has a list of functional capabilities that can be predefined through the structural definition of the knowledge graph. These capabilities may include (but not limited to): message passing, pooling, routing, averaging, aggregation, concatenation, convolution, memory, arithmetic operations, logic functions, ontological functions, learning functions, query processing, etc. The functions defined for the entities can also be application-specific (e. g. financial market related, risk-related, credit-related, NLP, and compliance functions). FIG. 2 is a schematic block diagram showing functional capabilities of an example entity. As shown, the entity 200 includes processing 205, storage 210, communication 215, learning 220 and application-specific 225 capabilities.

In terms of connections between entities, connectivity between a first entity Ei and a second entity En can be calculated through a sequence of message passing operations. In some implementations, community detection can be calculated over entity level strength assignments and comparisons with neighbors through message passing. Node embeddings may be calculated locally in a similar manner through message passing, aggregation and concatenation functions. Additionally, an unknown connection between two entities can be learned through inference. Furthermore, in certain embodiments, knowledge can be acquired through message passing as described herein, with the knowledge graph being updated in view of the processed content of the messages that have been passed. In some embodiments, these capabilities can be performed at the entity level in the neuromorphic hardware by leveraging the storage, computing, learning and communication capabilities of the hardware, which in turn provides the opportunity to use the knowledge graph in a distributed mode in which operations can be performed in parallel.

Through the added entity-level, functional, and relationship capabilities, the knowledge graph of the present disclosure becomes an integrated knowledge processing system or computational knowledge graph with both traditional database capabilities as well as computational capabilities. The computational knowledge graph has numerous advantages including response time and performance improvements, resilience, and increased parallelism. As one significant example, the individual entities can calculate and store their own embeddings which enables numerous machine learning algorithms to run efficiently on the resulting knowledge graph.

For each entity Ei of type X in the knowledge graph, a process is followed to identify what functions are needed for provisioning the entity. This provisioning process begins with a lookup query directed to access functional libraries that provide information concerning the required functionalities based on entity type. Entity types can be related to certain fields or applications, such as financial applications. While some of the functionalities allocated to each type are generic computing functions such as arithmetic operations, logic operations etc., others are specific to the entity type. such as for financial applications. For financial applications, specialized functions defined can include compliance, legal, risk-related functions and market-related functions. In addition to entity type, entity size and other characteristics (location, region, territory and other factors) can also affect the functions defined for and allocated to the entities. Functional libraries can be configured to determine additional functions or customized functions required. For larger and complex entities, learning capabilities, and other specialized functions such as routing, pooling or inference can be required. Once the functional capabilities of entity Ei are determined, the entity is assigned the functional capabilities. Hardware mapping or software modification can then proceed to configure the pertinent capabilities into entity Ei.

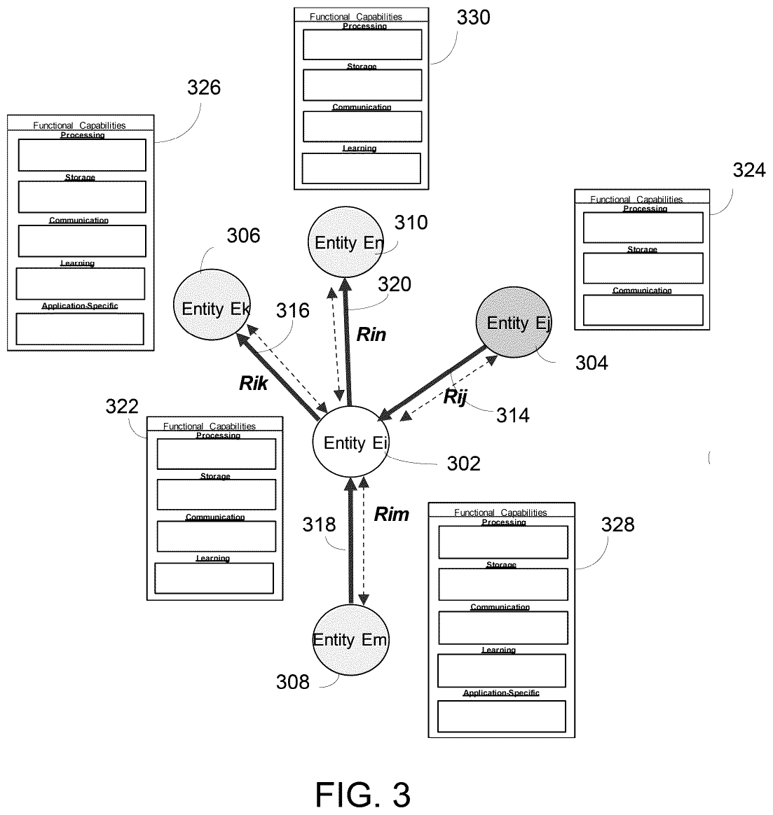

FIG. 3 is a schematic diagram illustrating a computational knowledge graph with entities having a range of different capabilities. The computational knowledge graph 300 includes five entities Ei 302, Ej 304, Ek 306, Em 308, and En 310. Ei 302 is a central entity and each of the other entities Ej 304, Ek 306, Em 308, En 310 are directly related to Ei 310. More specifically, Ei 302 and Ej 304 are related via relationship Rij 314, Ei 302 and Ek 306 are related via relationship Rik 316, Ei 302 and Em 308 are related via relationship Rim 318, and Ei and En are related via relationship via relationship Rin 320. Each of the entities Ei through En has a set of capabilities as shown in blocks 322-330. In the example depicted, entity Ei is configured with capabilities 322 including processing, storage, communication and learning; entity Ej is configured with capabilities 324, including processing, storage, and communication; entity Ek is configured with capabilities 326 including processing, storage, communication, learning and application-specific capabilities; entity Em is configured with capabilities 328, including processing, storage, communication, learning and application-specific capabilities; and entity En is configured with capabilities 330, including processing, storage, communication and learning. As shown, the entities can have different capabilities, and some entities can have more capabilities than others.

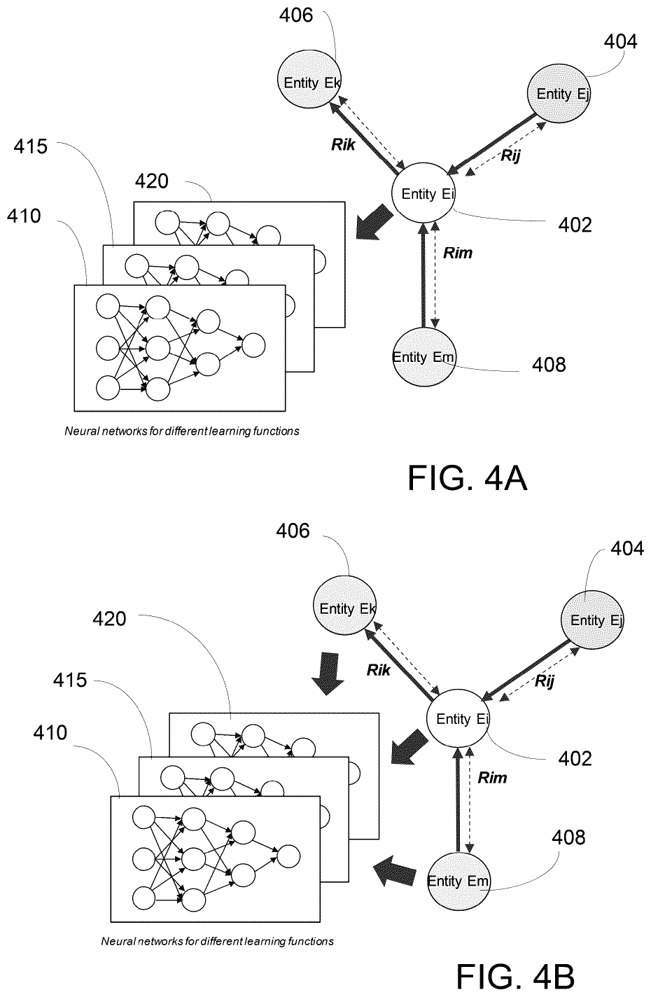

FIGS. 4A and 4B are schematic diagrams depicting two examples of using learning functions with entities in the computational knowledge graph. In the example shown in FIG. 4A, there are four entities, Ei 402, Ej 404, Ek 406 and Em 408, with Ei 402 being central, and related directly to the other three entities Ej, Ek and Em 404, 406. 408. During processing of queries, updating or other operations of the knowledge graph, entity Ei accesses different learning functions 410, 415, 420. One of the purposes of accessing the learning functions 410, 415, 420 may be to determine one or more inferences from data communicated between the entities. FIG. 4B shows the same entities and relationships as in FIG. 4A, but in this example, entities Ei 402, Ek 406 and Em 408 can all access learning functions 410, 415, 420 for processing. To perform certain tasks, each of the entities Ei, Ek, Em can access all of the learning functions 410, 415, 420. But in other cases, entities access one or more but less than the total number of learning functions to perform a particular operation.

The computational knowledge graph processes operations including connectivity checks, queries and inference tasks among others. In some implementations, queries are processed such that the individual entities are assigned partial query tasks which can then be integrated locally in the graph or compiled at the system level to output the query results. For complex queries, the query can first be pre-processed to break the query into different components. The query components can then be sent to the localized entities and functional units to be processed within the locality of the knowledge graph regions that the query relates to. The entire processing of the query can involve message passing, data processing, computing, and learning as well as other tasks involving one or more entities, and one or more procedural steps. These processing general end in a result referred to as the query output. For other knowledge graph operations, tasks can also be assigned to local entity nodes for processing, or alternatively (or additionally), can be distributed between centralized processing and local processing and anything in between. This flexibility improves the overall efficiency and performance of the knowledge graph system.

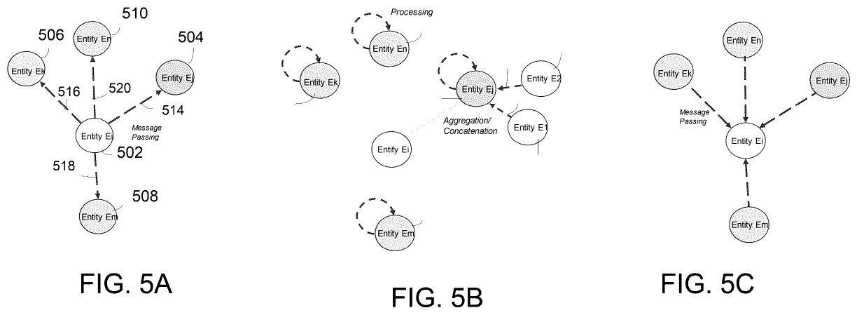

FIGS. 5A, 5B and 5C illustrate stages of an example method for processing a query in a (simplified) computational knowledge graph according to the present disclosure. In FIG. 5A, there are five entities in this simplified example, Ei 502, Ej 504, Ek 506, Em 508 and En 510. Entities Ej 504, Ek 506, Em 508 and En 510 are directly related to Ei 504. In this first stage, Ei 502 sends out query messages to all of the related entities, Ej 504, Ek 506, Em 508 and En 510 along respective connection paths 514, 516, 518, 520. FIG. 5B shows a second stage of the query in which entities Ej 504, Ek 506, Em 508 and En 510, after receiving the query messages from Ei 502, perform local processing to obtain the information to answer the query. In addition, in furtherance of the goal of answering the query, entity Ej 504 passes additional messages to further entities E₁ 522 and E₂ 524, to obtain information. The information obtained from E₁ 522 and E₂ 524 can be aggregated and concatenated prior to being received by Ej 504. In a final stage of the query process shown in FIG. 5C, entities Ej 504, Ek 506, Em 508 and En 510 return results of their processing and data gathering to entity Ei 502, in response to the query.

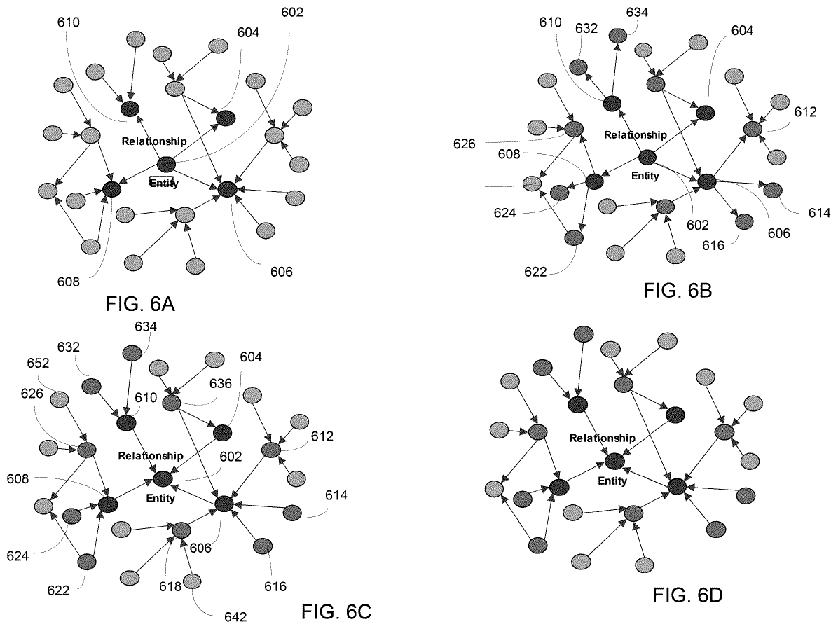

FIGS. 6A-6D illustrate stages of a more complex query processing example according to the present disclosure. In a first stage shown in FIG. 6A, entity 602 originates a query and broadcasts messages related to the query to the other entities to which it is directly related by a known relationship, 604, 606, 608 and 610. Entities 604, 606, 608, 610 are here referred to as the “neighbors” of entity 602. In a second stage shown in FIG. 6B, each of the neighbor entities 604-610 broadcasts query messages to their own respective neighbors. More specifically, entity 606 broadcasts messages to further neighbors 612, 614, and 616; entity 608 broadcasts messages to neighbors 622 and 624; and entity 610 broadcasts messages to entities 632, 634, 636. These “second-level” neighbors can receive information from other entities shown in the knowledge graph (but not separately numbered). In FIG. 6C, a third stage the larger group of entities to which the messages have been broadcast process the instructions in the query messages and return results, parts of which may include information from additional “third-level” entities as noted above. In the example, entity 606 receives results from second-level entities 612, 614, 616 and 618. In turn, second-level entity 612 receives and aggregates (it is understood that aggregation can also include concatenation) information from third level entities, e.g., 642. Similarly, entity 608 receives and aggregates results from second-level entities 622, 624 and 626. Second-level entity 626 receives and aggregates information from third-level entities, e.g., 652. Likewise, entity 610 receives and aggregates results from second-level entities 632, 634 and 636. In a final stage shown in FIG. 6D, entities 604-610, upon receipt of information from the second, third, etc. of the knowledge graph then return results to the originator entity 602. It is noted that the processing of any of the entities in the knowledge graph can include access to additional functions, including learning functions.

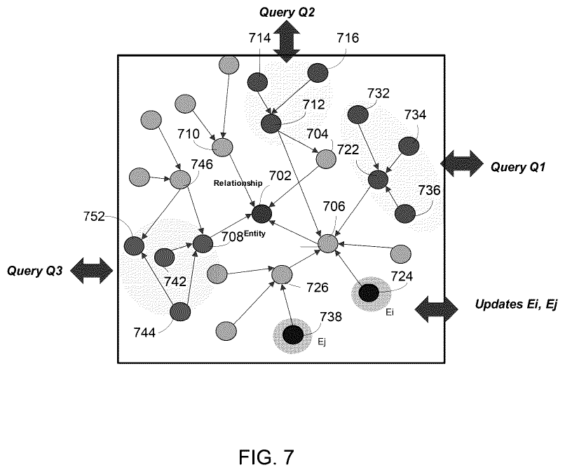

FIG. 7 depicts an alternative embodiment in which a several queries and update processes are processed by a computational knowledge graph in parallel. In computational knowledge graph 700 entity 702 is related directly to four other entities 704, 706, 708, 710 as in previous examples. Entity 704 is in turn directly related to second-level entity 712. Second-level entity 712 is further directly related to third-level entities 714 and 716. Together, entities 712, 714 and 716 form a “first group” that is assigned the task of processing a first query Q1. Entity 706 is directly related to second-level entity 722, 724, and 726. Second-level entity 722 is further related to third-level entities 732, 734 and 736. Together, entities 732, 734 and 736 form a “second group” that is assigned the task of processing a second query Q2. Both Q1 and Q2 can proceed with interaction with further graphs or systems external to the depicted computational knowledge graph 700 as indicated by the double-headed arrows at the external border of the knowledge graph.

Second level entity 724 is an entity labeled Ej that requires updating. This update process, which again can involve components outside of the knowledge graph 700 also takes place in parallel with queries Q1, Q2. Furthermore, second-level entity is in turn related to third-level entity 726 is related to third-level entity 738. This entity (Ek) also requires updating. This process further occurs in parallel with queries Q1, Q1 and the updating of entity Ei.

In addition, entity 708 is directly related to second-level entities 742, 744 and 746. Entity 744 is related to third-level entity 746. Together, entities 742, 744 and 746 form a “third group” which is assigned the task of performing a third query Q3. Q3 is likewise processed in parallel with the other queries Q1, Q2 and with the updating tasks for Ei and Ej. In this manner, a computational knowledge graph with a small number of components can still be involved in a number of simultaneously performed parallel tasks.

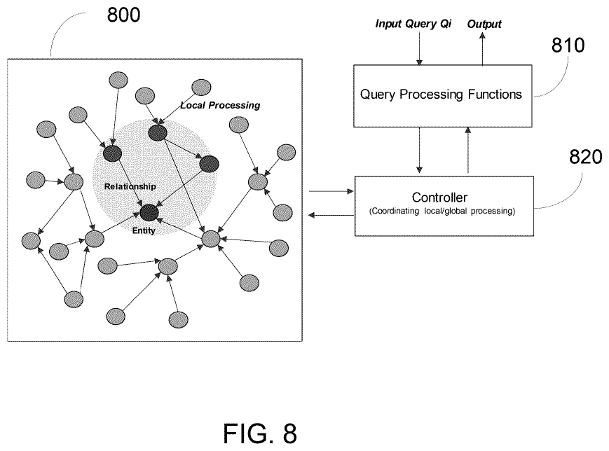

FIG. 8 is a schematic block diagram of a system for carrying out queries and other operations using a computational knowledge graph according to the present disclosure. As shown, the computational knowledge graph 800 is communicatively coupled to a controller 810 that is configured to coordinate local and global processing. As described further below, the controller, can comprise neuromorphic hardware, firmware such as field-programmable gate arrays (FPGAs), and/or conventional processing units such as microcontrollers and CPUs. The controller 810 is coupled to an input/output interface 820 for receiving queries as inputs and outputting results in response to the queries. In the arrangement of FIG. 8, the controller 810 mediates between the knowledge graph and external interfaces, allowing the knowledge graph to perform processing functions without having to directly coordinate inputs and outputs with external interfaces.

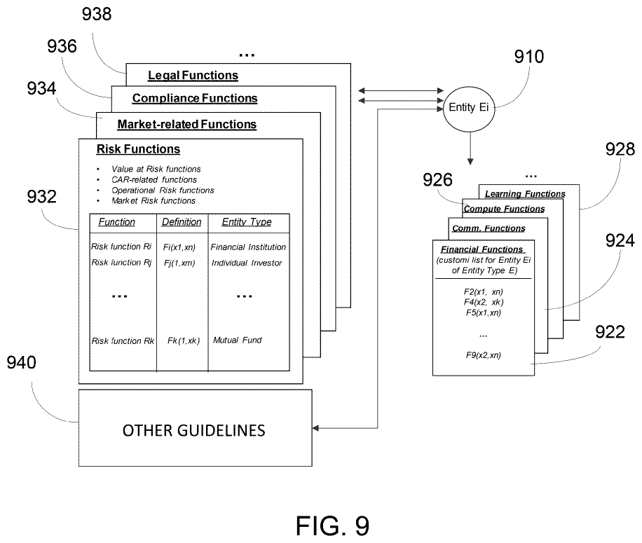

The queries processed by the knowledge graph can draw on application-specific functionalities which the entities can be configured with according to type. FIG. 9 is a schematic block diagram showing general functional libraries that can be used for configuring entities as well as libraries for customizing entity-level characteristics suited for particular applications. In FIG. 9, entity 910 is coupled to a set of general functional libraries including libraries of financial functions 922, communication functions 924, computation functions 926 and learning functions 928. The financial functions 922 are configured for the particular entity 910 or for its entity type. The entity 910 is also shown coupled to a set of libraries for customizations according to entity type including libraries of risk functions 932, market-related functions 934, compliance functions 936 and legal functions 938. It is noted that the diagram shown in FIG. 9 is illustrative and that the entity 910 is not necessarily coupled to the various sets of libraries and functions in the manner depicted. The risk-related functions 932 shows an exemplary table having columns labeled functions, definitions and entity type. The table illustrates have a number of different functions are defined with distinct formulae and that each function is associated with a particular entity type. Entity 910 is also shown coupled to other guidelines 940 which can include size and capitalization, geographical location (US, EU, etc.), an territorial risk-based guidelines. Depending on these factors, a more extensive function list can be indicated, for example, for a higher risk entity.

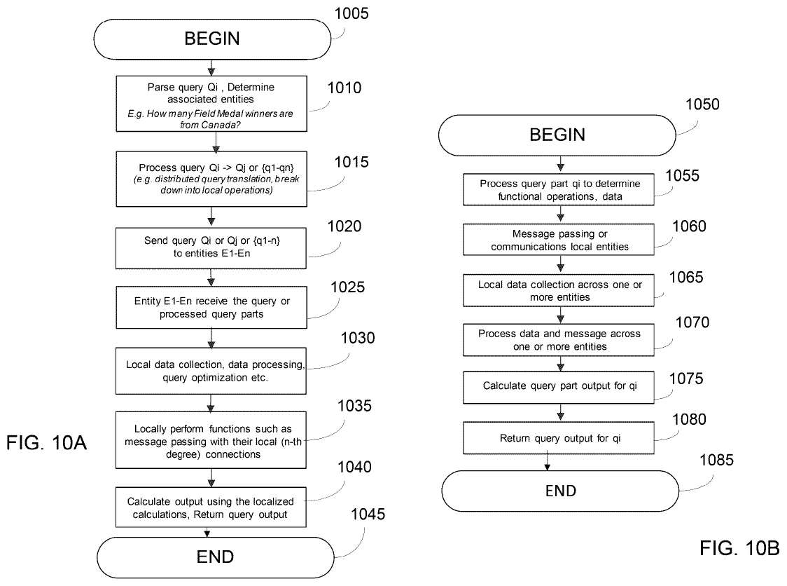

FIG. 10A is a flow chart of an exemplary method for processing a query using a computational knowledge graph according to an embodiment of the present disclosure. The method begins in step 1005. In the following step 1010, query Qi is parsed to determine the entities of the computational knowledge graph that are likely to be most related to the query. The query can be parsed with natural language processing and/or machine learning functions for this purpose. In the next step of the process 1015, query Qi is broken down into components (q1-qn) for distributed local processing. In step 1020, the query components q1-qn are delivered to entities E1-En deemed most optimal in step 1010 and the entities receive the query components in step 1025. Upon receipt of the query components q1-qn, entities E1-En perform local data collection and processing, query optimization and other tasks involved in gathering data appropriate for responding to the query. In the following step 1035, this process is extended by message passing with local connections (i.e., first through nth level connections, as described above). In step 1040 a query output is determined using the local calculations and results of message passing and then returned. The method ends in step 1045.

FIG. 10B is a flow chart of an example method for processing a query component at the entity (local) level according to an embodiment of the present disclosure. The method begins in step 1050. In a following step 1055, the entity processes query component qi to determine functional operations required to be performed, data to be gathered, and further entities to message.

In step 1060, the entity passes messages to the local entities as determined in step 1055. Local data collection among the messaged entities proceeds in step 1065. In step 1070, the original entity and messaged entities, in concert, process the data and communicate further among each other, as needed and determined by each data processing operation. After the data processing operations, an output for query component qi is calculated in step 1075, and the query component is returned in step 1080. In step 1085, the method ends.

It is noted that steps for generating and updating the knowledge graphs can proceed in different orders depending on the application. As an example, while in many cases it the knowledge graph can be generated starting with the entities and relationships between the entities, it is possible to generate a knowledge graph starting with function descriptions first, and populating the knowledge graph with entities and relationships subsequently. Updating can proceed in different orders and directions as well.

### System Implementations

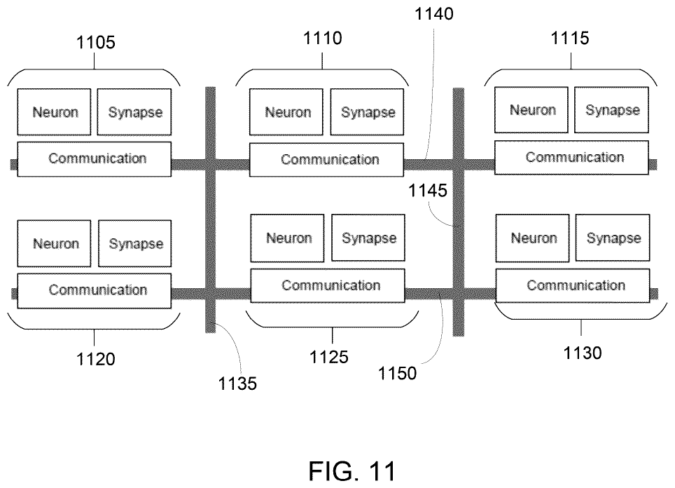

The above-described computational knowledge graph can be embodied in a number of different ways. The entities and relationships can be embodied directly in hardware configurations or, alternatively, can be configured using firmware/software using conventional hardware elements. FIG. 11 is a block diagram of a system embodiment for a computational knowledge graph according to the present disclosure. AI/ML systems have been increasingly reliant on specialized hardware such as tensor processing units (TPUs) and graphic processing units (GPUs). More recently, neuromorphic chips have been developed that attempt to simulate the manner in which neurons process information. Neuromorphic architecture is particularly suited for providing a platform architecture for a computational knowledge graph because neurons and be analogized to entity nodes and synapses can be analogized to relationships/connections. FIG. 11 is a schematic diagram that illustrates a generalized neuromorphic architecture model that can be used in the context of a computational knowledge graph according to the present disclosure. The neuromorphic architecture model includes six neural computational units (neural elements) 1105, 1110, 1115, 1120, 1125, 1130 coupled in via a grid of conductive paths 1135, 1140, 1145, 1150. In this manner, neural computational units can be arranged in arrays, and will be referred to herein as “neural arrays.” Each of the neural elements includes a neuron, synapse and a communication interface. In a computational knowledge graph, each entity can be implemented using one of the computational units e.g., 1105-1130. The neuromorphic architecture has certain advantages over traditional Von Neumann architecture model in which computing, communication and memory/storage functions are separated. In the Von Neumann architecture there is an implicit memory bottleneck between the processor and main memory. This bottleneck has caused poor performance in data intensive applications. In the neuromorphic architecture as shown in FIG. 11 the neuron/synapse combination includes both processing and memory capability. While GPUs and other hardware accelerators are frequently used in financial services computing infrastructure, they do not solve the source of the problem, which is the full separation of the computing, communication and storage capabilities in the Von Neumann architecture. With the availability of the neuromorphic chips the implementation of knowledge graphs can be improved dramatically.

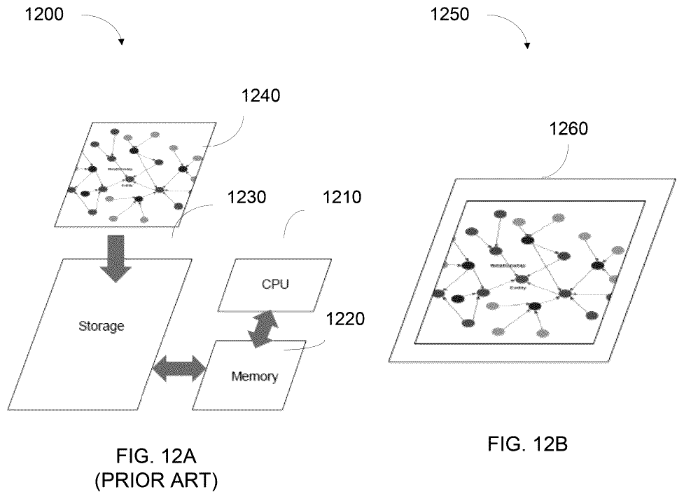

The difference between using a conventional Von Neumann architecture and a neuromorphic architecture for a knowledge graph is further illustrated in FIGS. 12A and 12B in which the two types of architecture are shown side-to-side. FIG. 12A illustrates a Von Neumann architecture 1200. A central processing unit (CPU) 1210 is coupled directly to local memory 1220 for rapid memory access. The CPU 1210 is also coupled to main memory 1230 more indirectly, leading the bottleneck issue. The computation knowledge graph 1240, which can be of arbitrary scope, can include elements stored in main memory 1230. Therefore, processing the knowledge graph in the Von Neumann architecture necessarily involves operations between the CPU and main memory which is subject to the bottleneck and pipelining difficulties. In contrast, in the neuromorphic architecture 1250 shown in FIG. 12B, the processing and memory resources are within the knowledge graph 1260 itself. There is no bottleneck between memory and processing elements. Accordingly, access to data, which is one of the main purposes of employing knowledge graphs, is considerably more rapid.

By localizing the computing processes within the computation knowledge graph architecture, the knowledge graph effectively becomes a “fully integrated” knowledge graph system with embedded computing, communication and storage capabilities. The integrated knowledge graph system can i) store knowledge graph data such as entities, relationships, schema, characteristics etc.; ii) process knowledge graph queries and algorithms; and (iii) update the underlying data, relationships, schema and other aspects of the knowledge graph. By localizing these the overall efficiency of the entire knowledge graph system is improved end-to-end and many of the aforementioned problems are addressed. As noted, the integrated knowledge graph system is particularly useful in the context of financial services, in which transactions need to both refer to volumes of distinct data sources and be processed quickly.

Neuromorphic architectures can be usefully applied to provide an integrated knowledge graph system by combining computation, storage and communication capabilities in the building block level (e.g. same synapse or local processing region, or entity/relationship-level). This localization provides key advantages in the performance and efficiency of knowledge graphs which is particularly important for application in the financial services and other industries because knowledge graphs are frequently in the critical path of time-sensitive functions such as transaction approvals. As one example, if an overseas wire transaction is submitted by a client, a knowledge graph is accessed to identify the recipients' connection to the sender, to calculate the financial crime risk with respect to the proximity of money laundering groups in the knowledge graph, among other operations. For large financial knowledge graphs with tens/hundreds of millions of entities and billions of connections, such transactions are challenging for conventional architectures which cannot achieve desired or required real-time processing and time sensitive performance. The speed of knowledge graph access, queries and operations are key to the success of many financial transaction and operational systems.

Some neuromorphic chips and architectures that have made available include the Loihi 2 system from Intel Labs, the TrueNorth chip developed by IBM, SpiNNaker and BrainScaleS developed by the Human Brian Project funded by the European Union. With the use of multiple processor cores, neuromorphic architectures can be simulated using Von Neumann architectures with software that create “Spiking Neural Networks.” Software modules such as Norse and BindNet build on PyTorch primitives in order to provide Spiking Neural network components that can be directly used in training algorithms.

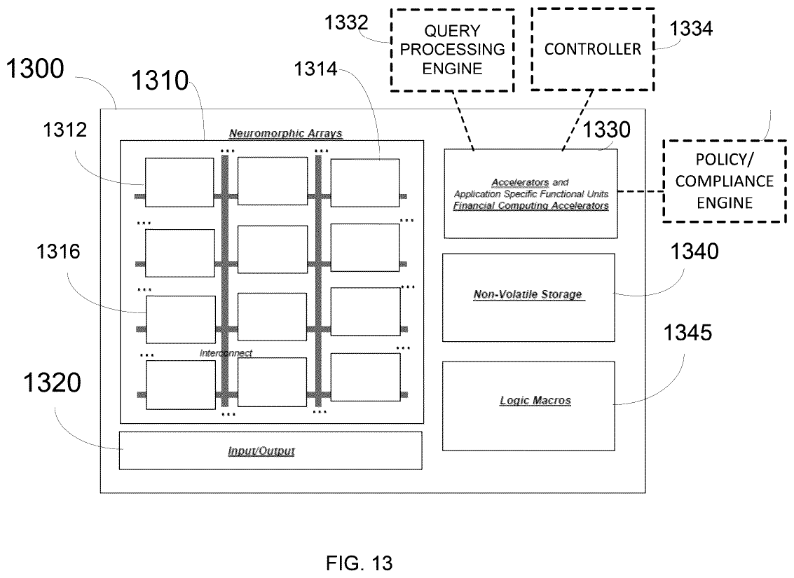

FIG. 13 is a schematic block diagram of an embodiment of an integrated knowledge graph system for implementing a computational knowledge graph according to the present disclosure that uses a neuromorphic architecture. The system 1300 includes neural arrays 1310 including individual neural elements e.g., 1312, 1314, 1316. The neural elements 1312, 1314, 1316 stimulate neuron and synapse function as well as data storage and processing functions of the computational knowledge graph. It is noted that the system can include multiple sets of neural arrays and not only a single array as shown. The neural arrays 1310 are coupled to an input/output interface 1320 which is configured to send and receive query requests and outputs and to deliver the requests to the pertinent elements of the neural arrays and to pass outputs to the other components of the system. In the embodiment shown, the neural arrays 1310 are coupled to one or more accelerators or Application Specific Functional Units (ASFUs) such as Financial Computing Accelerators (termed “accelerators” for brevity) 1330. The accelerators are particularly efficient in performing certain heavy computational tasks. One of the purposes of the accelerators serve is to process specific functions (e.g., mathematical or financial functions) in conjunction with data received from the neural arrays.

In some embodiments, one accelerator is configured as a parallel query processing engine 1332 that is configured to process and parse incoming queries and to address the queries to different elements of the neural arrays 1310 in conjunction with the input/output interface 1320. Key knowledge graph operations such as transaction processing can require expedited access to the knowledge graph in real-time. This requires short response times and agile querying capabilities in some cases. For such cases, the parallel query processing engine 1332 provides the underlying system with enhanced ability to respond in real-time. Furthermore, the parallel access and querying capabilities enable numerous parallel queries to be processed simultaneously in the system. The real-time parallel updates to the underlying knowledge graph are performed without any single point bottleneck.

Another accelerator is configured as a controller 1334 that orchestrates system level activities among the other components of the system. A further accelerator is configured as a policy/compliance engine 1336 that is tailored to financial applications. The policy/compliance engine 1336 manages and monitors on-system activities and ensures that policies and rules (e.g., legal and compliance rules) are enforced in whichever case such rules such as updates and transactions. The policy/compliance engine 1336 also provides the computational knowledge graph the ability to control access to critical data sources. As an example, if the knowledge graph includes critical information regarding the merger and acquisition states of an entity Ei (such as a company), this information, despite being normally accessible via the knowledge graph, can be access-restricted and only provided to a restricted group of employees and departments on a “need to know” basis. In some embodiments, the speed and parallelism can be adjusted according to financial risk-related parameters determined by knowledge graph computations. If a risk assessment is made about an entity Ei, the knowledge graph can be pooled for its neighbors and accelerated risk calculations may be performed. For example, value-at-risk (VAR) related functions can be computed for the pooled neighborhood of entity Ei resulting in a rapid query response.

Referring again to FIG. 13, the neural arrays 1310 and accelerators 1330 are coupled to on-board non-volatile memory 1340 and to additional logic macros 1345. The additional logic macros provide software instructions that orchestrate the neuromorphic simulation of the neural arrays. System 1300 can be implemented on a single electronic device, such as single neuromorphic chip.

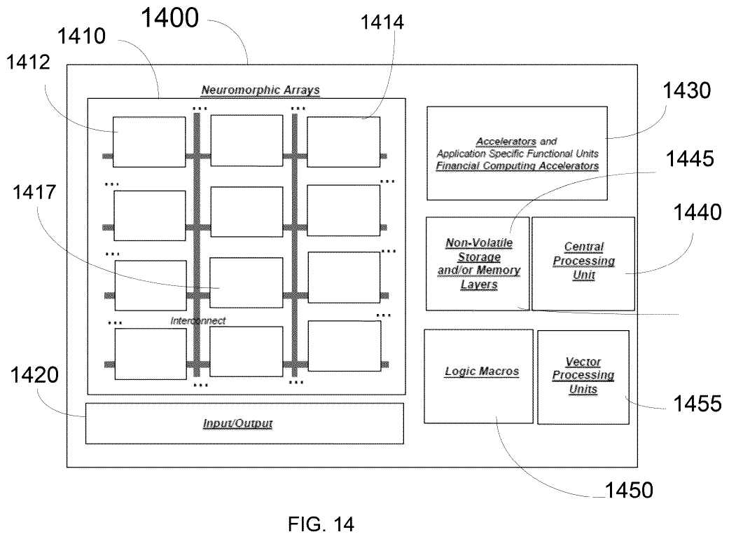

FIG. 14 is a schematic block diagram of an alternative embodiment of an integrated knowledge graph system for implementing a computational knowledge graph according to the present disclosure that employs aspects of conventional Von Neumann architecture. System 1400 also includes neural arrays 1410 including individual neural elements 1412, 1414, 1416 stimulate neuron and synapse function as well as data storage and processing functions of the computational knowledge graph. The neural arrays 1410 are coupled to an input/output interface 1420 which is configured to send and receive query requests and outputs and to deliver the requests to the pertinent elements of the neural arrays and to pass outputs to the other components of the system. In this embodiment similar accelerators 1420 can be used as in the embodiment shown in FIG. 13 above including a parallel query processing engine, controller and policy compliance engine (not explicitly shown in FIG. 14). An important difference between this embodiment and that shown in FIG. 13 is the inclusion of a central processing unit (CPU) 1440 with non-volatile storage and/or memory layers 1445. Logic macros 1450 can be processed in conjunction with a vector processing unit 1455 which is designed to process matrix operations, as are used in machine learning algorithms, more efficiently. In this embodiment, much of the functionality of the computational knowledge graph is preserved but the bottlenecks caused by the separation of the CPU 1440 from the memory layers reduces optimal efficiency.

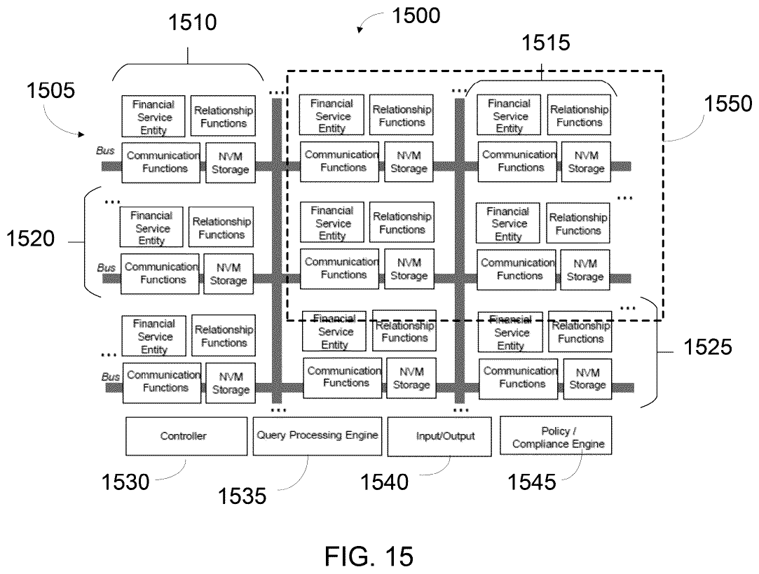

FIG. 15 shows a similar system as shown in FIG. 13 customized for a financial services application. The system 1500 depicted includes a neural array 1505 having neural elements e.g., 1510, 1515, 1520, 1525. In this embodiment, each neural element comprises a financial services entity (e.g., memory configured with data concerning the entity); relationship functions (memory and processing resources configured with data concerning relationships the entity has with other elements as well as processing functions); communication functions (processing resources and interfaces that allow messages to be sent from the entity to other neural elements in the neural array); and additional non-volatile memory storage to enable the neural element to stored data obtained from other elements and for other purposes. The neural elements can include further components as well, such as learning functions. The neural array 1505 is coupled to the engines described above including a controller 1530, a parallel query processing engine 1535, an input/output interface 1540 and a policy/compliance engine 1545. The dashed rectangle in the upper right of the figure represents a financial institution, such as a bank, which can comprise a plurality of related entities. FIG. 15 thus depicts how the neural elements can be configured as an integrated financial knowledge graph.

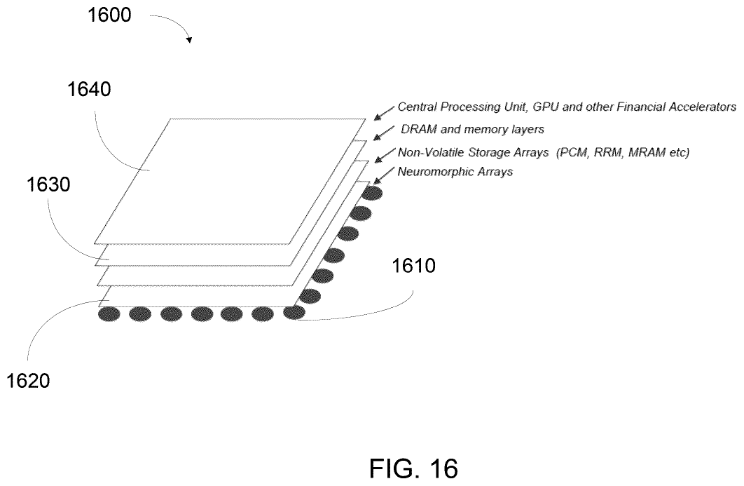

FIG. 16 shows one way in which the system of FIG. 15 can be implemented using an interposer or three-dimensional integrated architecture. The three-dimensional structure 1600 includes a number of stacked layers with computing, storage, communication, and neuromorphic, capabilities. The foundational layer 1610 comprises a plurality of neural arrays. Non-volatile storage arrays 1620 are stacked directly above and in communication with the neural arrays 1610. The non-volatile arrays 1620 can include one or more of phase-change memory (PCM), restrictive random-access memory (RRAM), magnetorestrictive random access memory (MRAM), and/or other non-volatile memory types known to those of skill in the art. A dynamic access memory (DRAM) and volatile memory layer 1630 is positioned over the non-volatile storage areas. The DRAM/memory layer 1630 functions in concert with the central processor unit (CPU) 1640 positioned above the DRAM/memory layer in the structure. The CPU can access data in the DRAM/memory layer 1630 comparatively quickly in comparison to data in the non-volatile arrays 1620.

In the embodiments of FIGS. 13-16, The system-level implementations integrate the knowledge graph functionalities, including computing, learning, communication and application specific functional capabilities on a dedicated system. As discussed, in some embodiments this dedicated system is a neuromorphic or custom chip. The systems can be used for mapping a knowledge graph onto the dedicated components. A knowledge graph, such as a financial knowledge graph, is mapped onto the integrated financial knowledge graph system through an algorithm which can be executed by the controller engine or other component discussed above. The algorithm takes into the account the characteristics of the knowledge graph entities and relationships, as well as the overall characteristics of the knowledge graph itself. The characteristics include individual entity-level characteristics, size, entity-type and functional requirements. The algorithm then maps the entity onto one or more arrays or functional blocks of the neural arrays by matching the capabilities of the underlying system components with the characteristics of the knowledge graph entities and relationships. For example, the algorithm determines whether an entity functional definition requires specialized accelerators, application-specific functional units or other macros. If they are required in the functional description of the entity then the mapping involves the corresponding functional structures in the system. The iterative process covers all entities and relationships, while gradually refining the assignments, until the entire mapping is completed such that all the entities their functional requirements and relationships are covered.

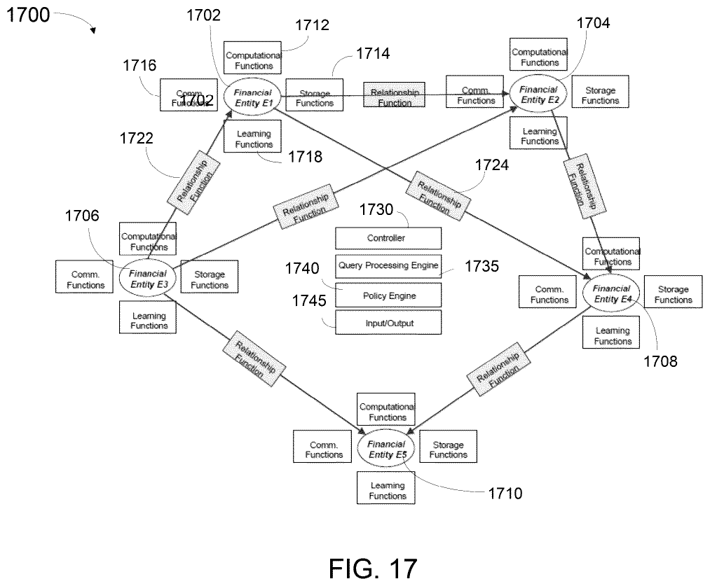

FIG. 17 is a schematic illustration of knowledge graph processing using the neuromorphic systems described above. The exemplary computational (integrated) knowledge graph 1700 includes five entities: E1 1702, E2 1704, E3 1706, E4 1708 and E5 1710. Each of the entities includes computational, storage, communication and learning capabilities. In FIG. 17, the capabilities of entity E1 1702 are expressly labeled: computation 1712, storage 1714, communication 1716 and learning 1718. The capabilities of the other entities are not labeled so as to not unnecessarily complicate the figure, but each of the entities E2-E5 (1704, 1706, 1708, 1710) has the same suite of capabilities as E1 1702. A number of relationship functions are drawn between the entities. For example, relationship function 1722 points between entities E3 1706 and E1 1702, and relationship function 1724 points between entity E1 1702 and E4 1708. FIG. 17 also illustrates the system-level engines that interact with and control the operation of the components of knowledge graph 1700. These engines are positioned in the center of FIG. 17 and include the controller 1730, query processing engine 1735, policy/compliance engine 1740 and input/output functions 1745.

Query operations are executed in parallel through the input/output interface and processed by the controller and policy/compliance engines. The query processing unit has a parallel architecture, capable of processing a number of queries in parallel. Individual entities and their functional units, as well as accelerators and other structures are involved to calculate the query output, which is then outputted through the I/O. Other knowledge graph operations such as updates, centrality calculations, inference, connectivity calculations, etc., are processed similarly, where the operations are sent to the individual entities, relationships and their functions. Once they are processed, their results are returned.

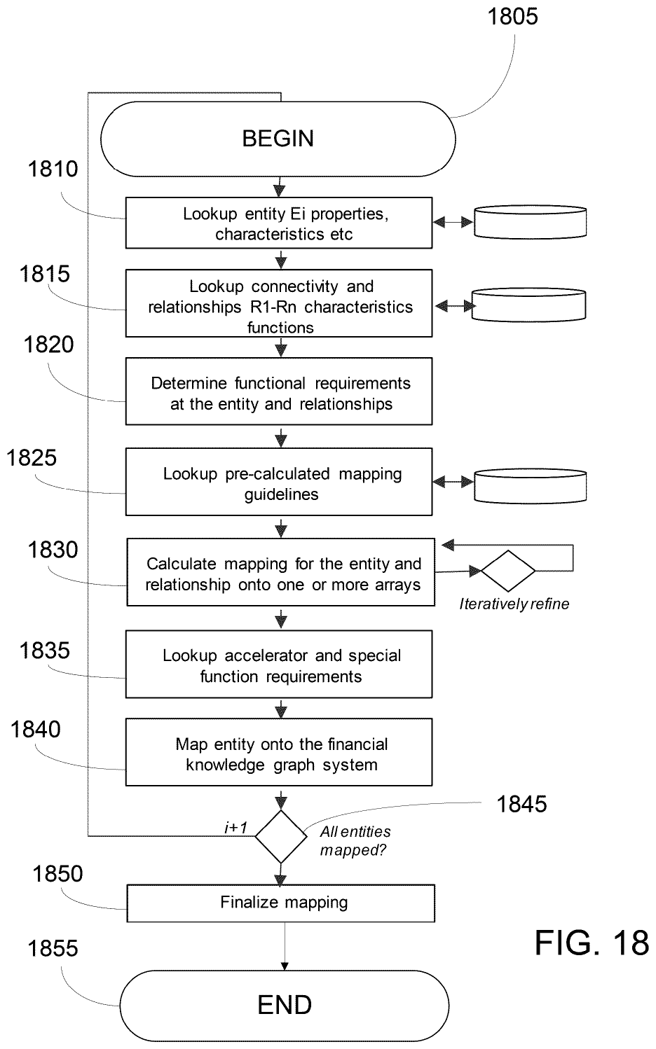

FIG. 18 is a flow chart of an embodiment of a method of mapping a computational knowledge graph according to the present disclosure. In certain embodiments, the steps of the method can be performed by a query processing engine, as described herein. The method begins in step 1805. In step 1810, the query processing engine looks up the properties of a particular entity E1 in one or more data stores. Once the characteristics of entity E1 are determined, the query processing engine then looks up the connectivity and relationships (R1-RN) that are associated with entity E1 and ascertains the properties and functions of the relationships in the same or additional data stores in step 1815. In a following step 1820, the functional requirements of the entity and relationships are determined via interaction with the same, fewer or additional data stores (further discussion of interaction with data stores will be understood by those of skill in the art and are omitted for brevity of discussion). In step 1825, the query processing engine looks up pre-calculated mapping guidelines. Once the guidelines are obtained, in step 1830, the query processing engine calculated the mapping for the entity and relationships onto one or more neural arrays. As shown, this can be performed in a loop in which the mapping is iteratively refined. In the following step 1835, the query processing engine looks up accelerator and special function requirements. Once the mapping has been calculated the acceleratory and special function requirements have been obtained, the query processing engine, in concert with the controller, maps the entity onto the computational knowledge graph. As per step 1845, the method cycles back to step 1805 if it is determined that further entities need to be mapped onto the knowledge graph. If there are no further entities to be mapped, the mapping is finalized in step 1850, and the method ends in step 1855.

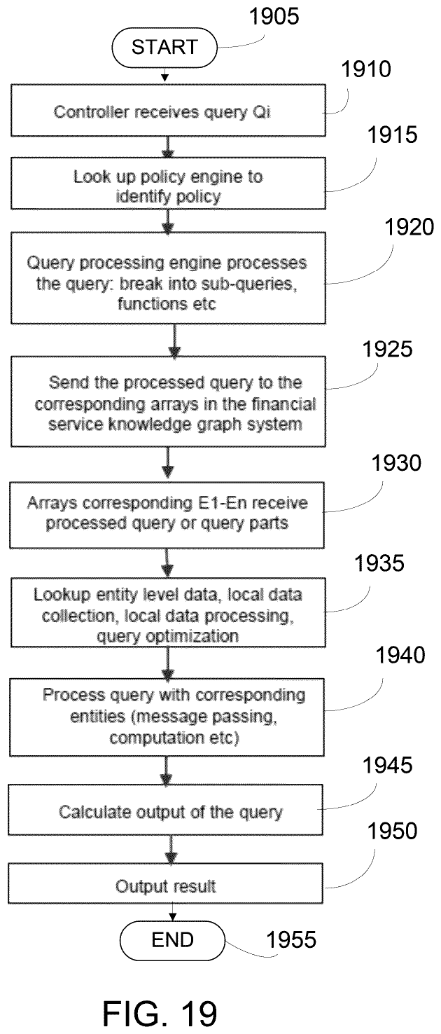

FIG. 19 is a flow chart of a method for query processing using policies according to an embodiment of the present disclosure. The method begins in step 1905. In step 1910, the controller receives a query Qi. In a following step 1915, the controller sends a look up request to the policy/compliance engine to identify relevant policies for the query which are sent to the query processing engine. Upon receipt of the relevant policies, in step 1920, the query processing engine receives the policies and processes the query, which can include breaking the query into multiple sub-queries and processes in a recursive manner and identifying portions (entities E1-En) of the knowledge graph that would be optimal for processing. In step 1925, the processed query is sent to corresponding neural arrays in the computational knowledge graph identified by the query processing engine. In a following step 1930, entities E1-En receive the processed query or query parts. The entities lookup local (entity-level) data, receive and process the local data and perform query optimizations in step 1935. After local processing, in step 1940, the entities E1-En communicate messages to one another to process the aspects of the query in concert. In step 1945, the output of the query is calculated based on the processing outputs of the entities E1-En to obtain a query results. The query result is outputted via output interface externally in step 1950. The method ends in step 1955.

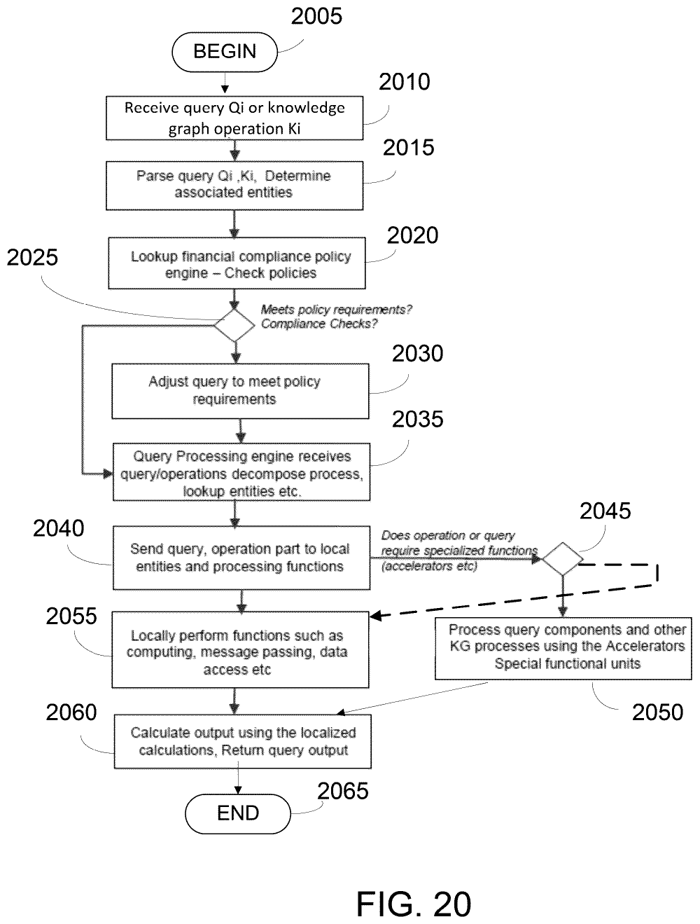

FIG. 20 a flow chart of another embodiment of a method for query processing using policies in a financial knowledge graph according to the present disclosure. The method begins in step 2005. In step 2010, a query Qi or knowledge graph operation Ki is received. In step 2015, the query Qi or operation Ki is parsed to determine associated entities of the financial knowledge graph. In a following step 2020, a request is sent to the policy/compliance engine to determine policies related to the query and associated entities. In step 2025, it is determined whether the query Qi or operation Ki meets with policy/compliance requirements. If it is determined in step 2025 that the query Qi or operation Ki does not meet with policy/compliance requirements, the method proceeds to step 2030 in which the query Qi or operation Ki is adjusted in order to comply with the policies (in this case query Qi becomes query Qi′ or operation Ki becomes operation Ki′). Conversely, if in step 2025 is determined that query Qi or operation Ki meets with compliance requirements the method proceeds to step 2035. In addition, once adjustment is complete in step 2025, the method also proceeds to step 2035 in which the query (Qi, Qi′) or operation (Ki, Ki′) is sent to the query processing engine decomposes the query/operation to determine entities of the knowledge graph optimal for processing the query. In step 2040, the query processing engine sends the query/operation (or parts thereof) to local entities and processing functions within the knowledge graph. After step 2040 it is determined in step 2045 whether the query/operation requires accelerators and/or special functions. If so, in step 2050, the query/operation is processed using accelerator and/or special functions. If it is determined in step 2045 that accelerators or special functions are not required, in step 2055 the query/operation is performed locally without acceleration or special functions using functions such computing, message passing, data access, etc. Following either step 2050 or step 2055, the method proceeds to step 2060 in which an output of the query or operation is calculated and the output returned. The method ends in step 2065.

The system-level implementations described above have a number of key advantages. The systems enable a high-level of parallel processing which can allow parallel queries among other operations. Parallel querying is of prime importance as the size and complexity of financial services knowledge graphs grow (involving tens to hundreds of millions of entities, numerous relationship types, complex schemas, etc.). Query reduction speed is particularly important for financial services which can require prompt answers to complex queries for decision-making. The improved speed and efficiency of the disclosed system-level implementations enable updating of large knowledge graphs in real-time through parallel access to the knowledge graph. Similarly, the improvements allow machine learning to be applied to large scale knowledge graphs in ways previously unfeasible and also allows parallel learning operations.

The system-level applications also improve data security. Financial knowledge graphs include critical data which can be subject to strict access control rules, regulatory and compliance checks. The on-board policy/compliance engine processes each query so that the access is restricted to only authorized entities as per policy guidance.

Another important feature of the systems disclosed herein is the incorporation of learning capabilities at the entity-block level. The entity-level features can draw upon the capabilities of specialized accelerator and application specific functions to further enhance the performance of financial queries and knowledge graph operations.

It is to be understood that any structural and functional details disclosed herein are not to be interpreted as limiting the systems and methods, but rather are provided as a representative embodiment and/or arrangement for teaching one skilled in the art one or more ways to implement the methods.

It is to be further understood that like numerals in the drawings represent like elements through the several figures, and that not all components and/or steps described and illustrated with reference to the figures are required for all embodiments or arrangements.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to a viewer. Accordingly, no limitations are implied or to be inferred.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

While the disclosure has been described with reference to exemplary embodiments, it will be understood by those skilled in the art that various changes may be made and equivalents may be substituted for elements thereof without departing from the scope of the disclosed invention. In addition, many modifications will be appreciated by those skilled in the art to adapt a particular instrument, situation or material to the teachings of the disclosure without departing from the essential scope thereof. Therefore, it is intended that the invention not be limited to the particular embodiment disclosed as the best mode contemplated for carrying out this invention, but that the invention includes all embodiments falling within the scope of the appended claims.

What is claimed is:

1. An integrated knowledge graph system comprising:
a plurality of neural arrays, each of the neural arrays containing circuits that represent neurons and synapses, each of the neurons and synapses having processing, communication, learning and storage capability, wherein entities and relationships of the knowledge graph are configured within the plurality of neural arrays;
a query processing engine coupled in parallel to the plurality of neural arrays and configured to process incoming queries and to pass process queries to targeted entities and relationships representing the plurality of neural arrays; and
a policy/compliance engine coupled to the plurality of neural arrays and configured to set policies for processing in the neurons and synapses of the plurality of neural arrays.

2. The integrated knowledge graph system of claim 1, wherein the query processing engine is configured to:
locate an entity represented in the knowledge graph within the plurality of neural arrays; and
pool neighbors of the entity in the knowledge graph as represented in the plurality of neural arrays.

3. The integrated knowledge graph system of claim 2, wherein the pooled neighbors in the plurality of neural arrays are configured to perform accelerated risk calculations.

4. The integrated knowledge graph system of claim 1, wherein the policy/compliance engine is configured to permit or restrict access to data represented in one or more parts of the knowledge graph represented in the plurality of neural arrays based on the set policies.

5. The integrated knowledge graph system of claim 1, further comprising one or more non-volatile memory storage units coupled to the plurality of neural arrays.

6. The integrated knowledge graph system of claim 1, further comprising:
a central processing unit (CPU) coupled to the plurality of neural arrays, the query processing engine and the policy/compliance engine; and
one or more vector processing units coupled to the CPU, the plurality of neural arrays, the query processing engine and the policy/compliance engine.

7. The integrated knowledge graph system of claim 1, wherein the plurality of neural arrays, the query processing engine, and the policy/compliance engine are implemented on a dedicated hardware device.

8. The integrated knowledge graph system of claim 7, wherein the plurality of neural arrays, query processing and policy/compliance engine are implemented on neuromorphic chip device.

9. The integrated knowledge graph system of claim 1, wherein the plurality of neural arrays, query processing and policy/compliance engine are implemented using a customizable hardware device.

10. The integrated knowledge graph system of claim 6, further comprising a three-dimensional architecture including one or more memory layers and wherein the CPU constitutes one layer of the three-dimensional architecture, wherein the CPU is interconnected to the one or more memory layers and the one or more memory layers are further interconnected to the plurality of neural arrays, which constitutes another distinct layer.

11. The integrated knowledge graph system of claim 10, wherein the one or more memory layers comprise a first dynamic memory layer coupled to the CPU and a second non-volatile storage array layer interconnected to the dynamic memory layer and to the plurality of neural arrays.

12. A method for mapping data onto a knowledge graph comprising:
receiving data targeted for mapping onto the knowledge graph;
identifying elements within the data including entity-level characteristics, size, entity-type, and functional requirements;
determining one or more neural arrays having capabilities suited for mapping of the identified elements, wherein the neural arrays contain circuits that represent neurons and synapses, each of the neurons and synapses having processing, communication, learning and storage capability; and
mapping the elements onto the suited neural arrays.

13. The method of claim 12 wherein, the neural array includes or is connected to functional block components configured to process the identified elements within the data, wherein the functional block components comprise at least one of a specialized accelerator and an application-specific functional unit.

14. The method of claim 12, wherein the one or more neural arrays are implemented on a dedicated hardware device.

15. The method of claim 14, wherein the one or more neural arrays are implemented on a neuromorphic chip device.

16. A method for querying a financial services knowledge graph comprising entity and relationship components that are configured and represented in a plurality of neural arrays comprising circuits that represent neurons and synapses, each of the neurons and synapses having processing, communication, learning and storage capability, the method comprising:
receiving a query for obtaining or updating information in a knowledge graph;
determining whether the query meets requirements for compliance by consulting a policy/compliance engine that is coupled to the plurality of neural arrays;
after the determining step, when requirements for compliance are not met:
restricting access to one or more components of the knowledge graph; and
adjusting the query to accommodate for the restricted access;
submitting the adjusted query, via an input/output system, to the knowledge graph to obtain or update the information in the knowledge graph.

17. The method of claim 16, further comprising after the determining step, when requirements for compliance are met, submitting the query, via an input/output system, to the knowledge graph to obtain or update the information in the knowledge graph.

18. The method of claim 16, further comprising:
sending results of the query including obtained or updated information to the policy compliance engine; and
determining whether the results of the query meet with compliance requirements.

19. The method of claim 16, wherein the input/output system submits multiple queries to the knowledge graph in parallel and the knowledge graph processes the queries in parallel.
